(19) United States
(12) Patent Application Publication
(10) Pub. No.: US 2024/0245069 A1
(43) Pub. Date: Jul. 25, 2024

(54) SYSTEMS, METHODS, AND DEVICES FOR FRACTIONAL EXTRACTION

(71) Applicant: Starbucks Corporation, Seattle, WA (US)

(72) Inventors: Matthew D. House, Seattle, WA (US); Elizabeth M. Guilherme, Seattle, WA (US); Jeffrey J. Chapman, Seattle, WA (US); Kieran A. Murphy, Seattle, WA (US)

(21) Appl. No.: 18/416,155

(22) Filed: Jan. 18, 2024

Related U.S. Application Data
(60) Provisional application No. 63/480,800, filed on Jan. 20, 2023.

(51) Int. Cl. A23F 5/26; A47J 31/34; A47J 31/44

(52) U.S. Cl. CPC A23F 5/262; A47J 31/34; A47J 31/4403

(57) ABSTRACT

A device for preparing an extract may have a plurality of extraction chambers. Each extraction chamber may include an aspect ratio where the aspect ratio is defined by dividing a length of each extraction chamber by a width of each extraction chamber. A flow of extraction medium may be introduced through the extraction chambers.

### INCORPORATION BY REFERENCE TO ANY PRIORITY APPLICATIONS

This application claims priority to U.S. Provisional Patent Application No. 63/480,800, filed Jan. 20, 2023, the entirety of which is incorporated herein by reference.

### BACKGROUND

### Field

The present disclosure relates to system, methods, and devices for preparing edible extracts, such as system, methods, and devices for preparing edible extracts with a plurality of extraction chambers.

### Description

Certain brewed beverages are prepared by extracting seeds, leaves, berries, or other plant matter containing desirable flavors, aromas, or compounds in a single extraction chamber. For example, espressos are commonly prepared by extracting roasted, ground coffee or espresso beans.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

In some embodiments, a method of preparing an extract can include: loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³; introducing a flow of extraction medium through the plurality of extraction chambers; withdrawing the extraction medium through the plurality of extraction chambers, wherein a TDS of the withdrawn extraction medium is between 4 percent and 10 percent and an extraction time of the withdrawn extraction medium is less than 20 seconds.

In some embodiments, the flow of extraction medium through the plurality of extraction chamber can be introduced at a pressure between 1 bar and 12 bar.

In some embodiments, each extraction chamber can have a length between 0.2 cm and 10 cm.

In some embodiments, there can be between 2 to 10 extraction chambers.

In some embodiments, a temperature of the extraction medium can be between about 85° C. and about 97° C.

In some embodiments, the extraction material can include coffee.

In some embodiments, an extraction device for preparing an extract can include: a plurality of extraction chambers, each extraction chamber having an interior volume for the extraction material and having a length (L) and a width (W) perpendicular to the length, wherein the aspect ratio A is defined by dividing the length (L) by the width (W) and the aspect ratio A is between 0.15 and 3.0 and wherein the interior volume of each extraction chamber is between 200 mm³ and 15,000 mm³.

In some embodiments, the extraction material can include a grind size between 200 microns and 400 microns.

In some embodiments, each extraction chamber has a length between 0.20 cm and 10 cm.

In some embodiments, there can be between 2 to 10 extraction chambers.

In some embodiments, each extraction chamber comprises a same aspect ratio A.

In some embodiments, a method of preparing an extract can include: loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³; introducing a flow of extraction medium through the plurality of extraction chambers; withdrawing the extraction medium through the plurality of extraction chambers.

In some embodiments, each extraction chamber can have a length between 0.2 cm and 10 cm.

In some embodiments, the flow of extraction medium can be introduced through each of the plurality of extraction chambers at a same time.

In some embodiments, the extraction medium can be withdrawn through the plurality of extraction chambers at a same time.

In some embodiments, a temperature of the extraction medium can be between about 85° C. and about 97° C.

In some embodiments, an extraction time of the withdrawn extraction medium can be reduced between 25 and 70 percent, as measured by double shot standards.

In some embodiments, a method of preparing an extract can include: loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³; introducing a flow of extraction medium through the plurality of extraction chambers; withdrawing the extraction medium through the plurality of extraction chambers, wherein an extraction time of the withdrawn extraction medium is reduced between 10 percent and 70 percent, as measured by double shot standards, while maintaining a volume of the extract and/or a TDS of the extract.

In some embodiments, the withdrawn extraction medium can have a concentration between 4 percent and 10 percent TDS.

In some embodiments, the extraction device can comprise between 2 to 10 extraction chambers.

In some embodiments, a temperature of the extraction medium can be between about 85° C. and about 97° C.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A illustrates an embodiment of a system for single chamber extraction.

FIG. 1B illustrates an embodiment of a system for fraction extraction.

FIG. 2A graphically illustrates a time required to produce a desired amount of extract when using the system for single chamber extraction of FIG. 1A.

FIG. 2B graphically illustrates a time required to produce a desired amount of extract when using the system for fractional extraction of FIG. 1B.

### DETAILED DESCRIPTION

Extracted or brewed beverages, such as coffee or tea, usually require extracting desirable flavors, aromas, or compounds from an extract (i.e., coffee beans, tea leaves, etc.) in an extraction chamber. An extraction material (e.g., heated or ambient water) is added to or forced through the extraction chamber to extract the desirable flavors, aromas, or compounds. However, as a desired amount/volume of the beverage increases, an extraction time required to extract the desirable flavors, aromas, or compounds from the extract in the chamber to produce the desired amount/volume of the beverage increases. The increased extraction time may reduce throughput of beverages or a rate at which beverages may be made while maintain a quality of the beverage.

The extraction chamber typically requires a large volume of extract to make a large amount/volume of the beverage. An aspect of the present disclosure is the recognition that an extraction chamber may require a specific aspect ratio (i.e., height divided by width) to produce beverage of expected quality. This may lead to single extraction chambers with a large height that require significant vertical space.

Therefore, it may be desirable to decrease the extraction time required to make the desired amount/volume of a beverage, while maintaining the specific aspect ratio of the extraction chamber so the quality of the beverage is maintained.

In accordance with several embodiments, the systems, methods, and devices described herein advantageously decreased the extraction time required to make a beverage while maintaining or even improving the quality of the extract. The systems, methods, and devices disclosure herein may include a plurality of extraction chambers. The plurality of extraction chambers may each have an aspect ratio that is the same as a single extraction chamber in order to maintain (or improve) the quality of the beverage. The plurality of extraction chambers may have a smaller height, while maintaining a same overall volume as a single extraction chamber. The plurality of extraction chambers may reduce the extraction time required to make a same volume of a beverage (of the equivalent or improved quality) when compared to the single extraction chamber, thereby increasing throughput or the rate at which beverages may be made.

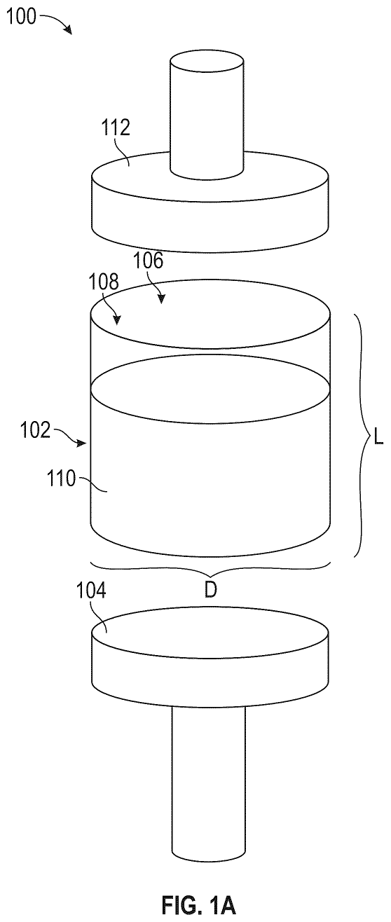

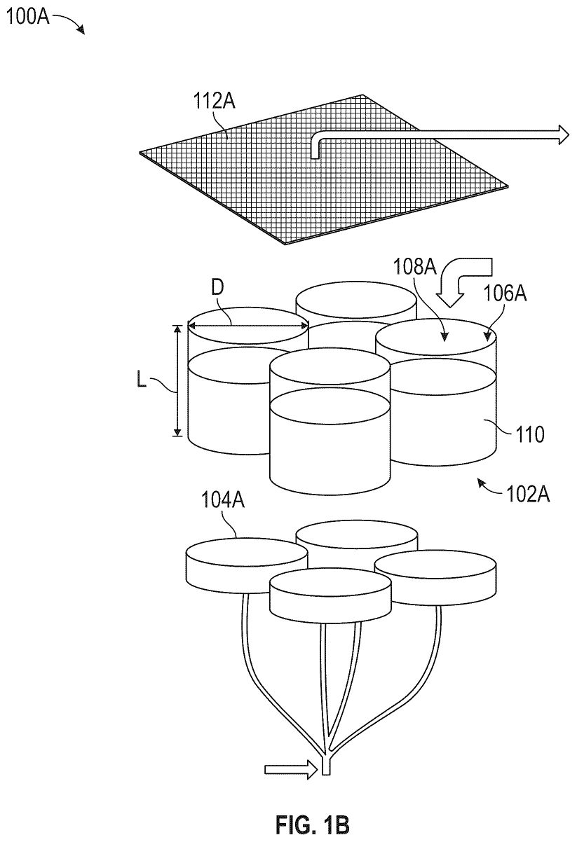

FIG. 1A shows an embodiment of a system 100 that uses a single chamber for extraction. The description of this single chamber system will be used to help describe certain features of multi chamber system that is describe below. The system 100 may include an extraction chamber 102, an inlet 104 and an outlet 106. The extraction chamber 102 may be formed by walls (not shown) of the system 100. The inlet 104 may be connected to a source of an extraction media (e.g., water) and the outlet 106 may be used to withdraw the extraction media from the chamber 102. The extraction chamber 102 may include a length L between the inlet 104 and the outlet 106 of the chamber 102 and a width D which is defined along the cross-section of the chamber perpendicular to the length L. In some embodiments, the inlet 104 of the chamber 102 may correspond to the initial surface of the extraction material in the chamber 102 and the outlet 106 may correspond to the final surface of the extraction material in the chamber 102. In some embodiments, the inlet 104 of the chamber 102 may correspond to a fluid inlet of the chamber 102 and the outlet 106 of the chamber 102 may correspond to a fluid outlet of the chamber 102. In some embodiments, the extraction chamber 102 may be a cylinder with a length and a cross-sectional shape that is a circle. In these embodiments, the width D of the extraction chamber 102 may be a diameter of the extraction chamber 102. In some embodiments, the cross-sectional shape may non-circular such as a triangle, a rectangle, a square, a trapezoid, a semicircle, an ellipse, a pentagon, a hexagon, an octagon, and/or any other shape. In these non-circular embodiments, the width D of the extraction chamber may be defined as the diameter of the largest circle that may be defined with the non-circular cross-sectional shape.

In some embodiments, the extraction chamber 102 may include an aspect ratio A. The aspect ratio A may be calculated or determined by dividing the length L by the width D (i.e., A=L/D). In certain embodiments, the aspect ratio A is between 0.5 and 1.0. In certain embodiments, the aspect ratio A is between 0.15 and 3.0.

The extraction chamber 102 forms an interior volume 108 along which the width D and length L defined above may be measured. In some embodiments, the interior volume 108 may have a volume of about 37,700 mm³ and may have a length of about 30 mm and width of about 40 mm. In some embodiments, the interior volume 108 may receive an extraction material 110 which may be manually or automatically loaded into the volume 108. In some embodiments, the extraction material may be an edible substance and may also be, in whole or in part (e.g., ground), at least one of green coffee cherries, red coffee cherries, white coffee, espresso coffee, coffee flowers, coffee cherry pulp, coffee cherry stalk, coffee cherry exocarp, or coffee cherry mesocarp. However, it should be appreciated that certain features and aspects of the embodiments disclosed herein may be applicable to other beverages besides coffee extracts, such as teas and other similar infusions. For example, in yet other embodiments, the extraction material may be green tea leaves and/or partially or totally dehydrated tea leaves. In still further embodiments, the extraction material may comprise fruits, nuts, or similar plant matter including vanilla beans, chocolate beans, hazelnuts, almond, macadamia, peanut, cinnamon, mint, apple, apricot, aromatic bitters, banana, blackberry, blueberry, celery, cherry, cranberry, strawberry, raspberry, juniper berry, brandy, cachaca, carrot, citrus, lemon, lime, orange, grapefruit, tangerine, coconut, menthol, ginger, licorice, milk, pecan, pistachio, walnut, peach, pear, pepper, among others. Thus, the description herein is not limited to espresso, coffee, coffee products, tea or tea products.

In some embodiments, an extraction medium may be used to yield an extract (i.e., beverage) from the extraction material 110 that is positioned within the volume 108. In some embodiments, common extraction methods known in the art may be used to yield an extract from the extraction material 110. For example, in certain embodiments, ground coffee is the extraction material and hot water is the extraction medium (or also referred to as extraction media) that is used to produce an extraction (e.g., espresso or brewed coffee).

In some embodiments, the extraction medium may be a cold extraction medium (i.e., not exceeding 100° F.). In some embodiments, the extraction medium may be a hot extraction medium (i.e., exceeding 100° F.). In some embodiments, the extraction medium may be a temperature between about 85° C. and about 97° C. or between 85° C. and 97° C. In some embodiments, the extraction medium may be a temperature of about 85° C., about 86° C., about 87° C., about 88° C., about 89° C., about 90° C., about 90.5° C. about 91° C., about 92° C., about 93° C., about 94° C., about 95° C., about 96° C., about 97° C., and/or any value between the aforementioned values with or without the term “about” before the stated value. In some embodiments, an extraction medium may be introduced or added to the interior volume 108 via the inlet 104. In some embodiments, the extraction medium may be a liquid such as water, but in some embodiments the extraction medium may be other liquids. In some embodiments, the extraction medium may be forced into the interior volume 108 at a pressure. In some embodiments, the pressure may be between about 1 bar and about 15 bar. In some embodiments, the pressure may be between about 1 bar and about 12 bar. In some embodiments, the pressure may be between about 5 bar and about 10 bar. In some embodiments, the pressure may be between about 9 bar and about 11 bar. In some embodiments, the pressure may be between 1 bar and 15 bar. In some embodiments, the pressure may be between 1 bar and 12 bar. In some embodiments, the pressure may be between 5 bar and 10 bar. In some embodiments, the pressure may be between 9 bar and 11 bar. In some embodiments, the pressure may be about 9 bar or 9 bar. In some embodiments, the extraction medium may be forced into the interior volume 108 via a piston or a plunger. In some embodiments, the extraction medium (now forming an extraction) may be withdrawn from the interior volume 108 via the outlet 106. In some embodiments, the extraction medium may be introduced or added to the interior volume 108 and held in the interior volume 108 for a period of time. The extraction medium or the extract (or referred to as an extraction) may be withdrawn from the interior volume 108 after the predetermined time. In some embodiments, the extraction medium may be introduced or added to the interior volume 108 and the extraction medium or the extract may be withdrawn from the interior volume 108 at the same time such that the extraction medium and/or the extract continuously flows through (i.e., into and out of) the interior volume 108 at a flow rate for the predetermined time.

In some embodiments, the extraction material 110 may include a grind size and/or a packing force. In some embodiments, the grind size may be between about 200 microns and about 400 microns. In some embodiments, the grind size may be between about 200 microns and about 300 microns. In some embodiments, the grind size may be between about 300 microns and 400 microns. In some embodiments, the packing force may be between about 0 kgF and about 60 kgF. In some embodiments, the packing force may be between about 0 kgF and about 40 kgF. In some embodiments, the packing force may be between about 20 kgF and about 60 kgF. In some embodiments, packing force may be between about 20 kgF and about 40 kgF.

In some embodiments, the outlet 106 may include a filter 112 that covers the outlet 106. The filer 112 may filter the extraction medium and/or the extract so none of the extraction material 110 is withdrawn from the interior volume 108 when the extraction medium and/or the extract is withdrawing from the interior volume 108.

FIG. 1B shows an embodiment of a system 100A for fractional extraction. Common features between the system 100 for single chamber extraction and the system 100A for fractional extraction will not be described again but are incorporated here in their entirety. In some embodiments, the system 100A for fractional extraction may include a plurality of extraction chambers 102A which may be defined by one or more walls (not shown) of the system 100A. In some embodiments, the plurality of extraction chambers 102A may be in parallel such that an extraction material may be added to or forced through each of the plurality of extraction chambers 102A at the same time. In some embodiments, the system 100A for fractional extraction may include two (2) extraction chambers 102A, three (3) extraction chambers 102A, four (4) extraction chambers 102A, five (5) extraction chambers 102A, six (6) extraction chambers 102A, seven (7) extraction chambers 102A, eight (8) extraction chambers 102A, nine (9) extraction chambers 102A, or ten (10) extraction chambers 102A. In some embodiments, the system 100A for fractional extraction may include more than ten (10) extraction chambers 102A. In certain embodiments, the system 100A includes between two (2) extraction chambers 102A and ten (10) extraction chambers 102A. In certain embodiments, the system 100A includes between two (2) extraction chambers 102A and eight (8) extraction chambers 102A. In certain embodiments, the system 100A includes between four (4) extraction chambers 102A and six (6) extraction chambers 102A. In some embodiments, the plurality of extraction chambers 102A may be sized such that the plurality of extraction chamber 102A may hold a same volume of extraction material 110 as the extraction chamber 102A of the system 100 for single chamber extraction. In some embodiments, the plurality of extraction chambers 102A may be sized such that a sum of the interior volume 108A of each of the plurality of extraction chambers 102A is equal to or about the interior volume 108 of the extraction chamber 102 of the system 100 for single chamber extraction.

In some embodiments, the extraction chamber 102 may include an aspect ratio A as defined above. The aspect ratio A may be calculated or determined by dividing the length L by the width D (i.e., A=L/D). In some embodiments, the aspect ratio A may be 0.05, 0.10, 0.15, 0.20, 0.25, about 0.30, 0.35, 0.40, 0.45, 0.50, 0.55, 0.60, 0.65, 0.70, 0.75, 0.80, 0.85, 0.90, 0.95, 1.00, about 1.05, 1.10, 1.15, 1.20, 1.25, 1.30, 1.35, 1.40, 1.45, 1.50, 1.55, 1.60, 1.65, 1.70, 1.75, 1.80, about 1.85, 1.90, 1.95, 2.00, 2.05, 2.10, 2.15, 2.20, 2.25, 2.30, 2.35, 2.40, 2.45, 2.50, 2.55, 2.60, about 2.65, 2.70, 2.75, 2.80, 2.85, 2.90, 2.95, 3.00, and/or any values between or about the aforementioned values. In some embodiments, the aspect ratio A may be greater than 3.00. In certain embodiments, the aspect ratio A is between 0.5 and 1.0. In certain embodiments, the aspect ratio A is between 0.15 and 3.0. In certain embodiments, the chamber 102A may have a length between about 0.2 cm and about 10 cm and a width between about 0.2 cm and about 10 cm. In certain embodiments, the chamber 102A may have a length of between about 0.5 cm and about 7.5 cm and a width of between about 0.5 cm and about 7.5 cm. In certain embodiments, the chamber 102A may have a length of between about 1 cm and about 5 cm and width of between about 1 cm and about 5 cm.

In some embodiments, the extraction chambers 102A may include a combined interior volume 108A. In some embodiments, the combined interior volume 108A may have a volume of between about 200 mm³ and about 40,000 mm³. In some embodiments, the combined interior volume 108A may have a volume of between about 200 mm³ and about 20,000 mm³ and may have a length of between about 0.2 cm and about 10 cm and width of between about 0.2 cm and about 10 cm. In some embodiments, the combined interior volume 108A may have a volume of between about 1,000 mm³ and about 15,000 mm³ and may have a length of between about 0.5 cm and about 7.5 cm and width of between about 0.5 cm and about 7.5 cm. In some embodiments, the combined interior volume 108A may have a volume of between about 5,000 mm³ and about 10,000 mm³ and may have a length of between about 1 cm and about 5 cm and width of between about 1 cm and about 5 cm.

Each individual extraction chamber may have an interior value of between 200 mm³ to 20,000 mm³.

In some embodiments, the outlets 106A of the extraction chambers 102A may each include separate filter 112A, or the outlets 106A of the extraction chambers 102A may include one filter 112 that cover all of the outlets 106A

In some embodiments, an aspect ratio A of each of the plurality of extraction chambers 102A may be equal to or about the aspect ratio A of the extraction chamber 102 of the system 100 for single chamber extraction. In some embodiments, the plurality of extraction chambers 102A may be sized such that a sum of the interior volume 108A of each of the plurality of extraction chambers 102A is equal to or about the interior volume 108 of the extraction chamber 102 of the system 100 for single chamber extraction, and an aspect ratio A of each of the plurality of extraction chambers 102A may be equal to or about the aspect ratio A of the extraction chamber 102 of the system 100 for single chamber extraction. For example, the extraction chamber 102 of the system 100 for single chamber extraction may have an interior volume 108 of about 40,000 mm³ and an aspect ratio A of 0.75, and the system 100A for fractional extraction may include four (4) extraction chambers 102A each with an interior volume 108A of about 10,000 mm³, and an aspect ratio A of 0.75. In this way, a same amount of extraction material 110 may be held in the interior volumes 108 and 108A, but the height L of each of the extraction chamber 102A may be smaller, reducing a vertical space needed for the extraction chamber 102A, and/or reducing a height needed for a piston or plunger.

In some embodiments, the total interior volume 108A (i.e., a sum of each interior volume 108A) may be equal to or about the interior volume 108 of the extraction chamber 102 of system 100, and a total surface area of the inlets 104A of the extraction chambers 102A (i.e., a sum of the surface area of the inlets 104A) may greater than the surface area of the inlet 104 of the extraction chamber 102 of the system 100.

By using a plurality of extraction chambers 102A with a smaller height L and a greater total surface area of the inlets 104A than a single extraction chamber 102 of system 100, a same amount of extract may be extracted from a same volume of extraction material in a shorter period of time.

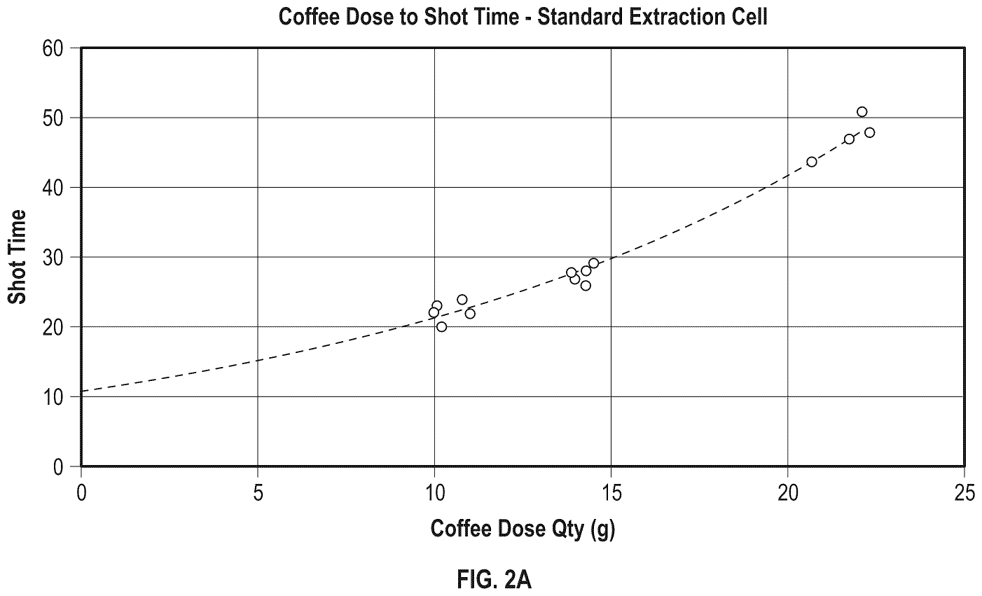

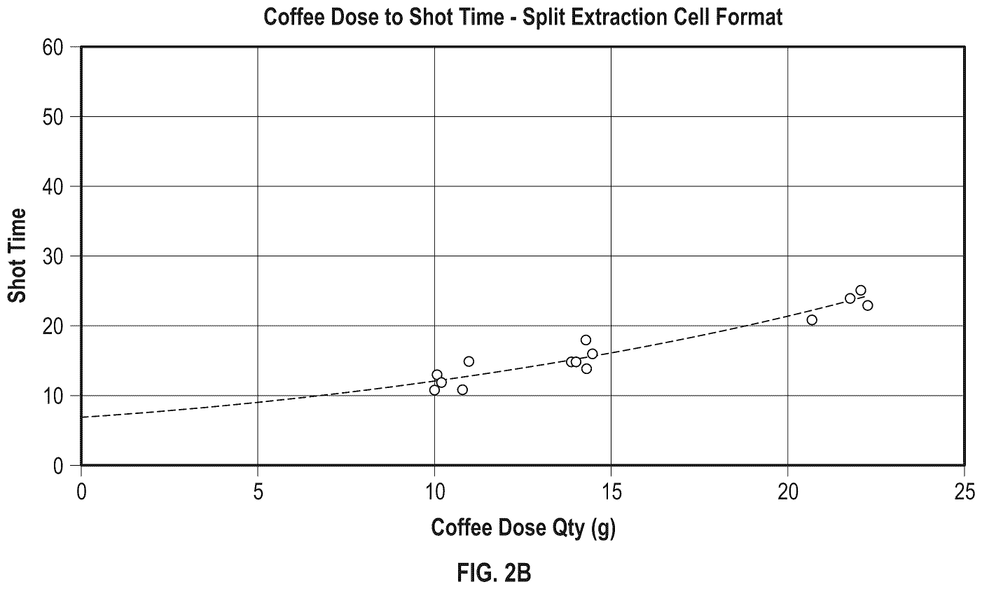

As shown in FIG. 2A, as a desired amount of extract (x-axis: Coffee Dose Qty) increases when using the single extraction chamber 102 of system 100, an extraction time required (y-axis: Shot Time) to extract the desired amount of extract increases. For example, a desired amount of extract of 10 g requires about 20 seconds of extraction time, and a desired amount of extract of 20 g requires about 40 seconds of extraction time.

As shown in FIG. 2B, as a desired amount of extract (x-axis: Coffee Dose Qty) increases when using the plurality of extraction chambers 102A of system 100A, an extraction time required (y-axis: Shot Time) to extract the desired amount of extract increases less than when using the single extraction chamber 102 of system 100. For example, a desired amount of extract of 10 g requires about 10 seconds of extraction time, and a desired amount of extract of 20 g requires about 40 seconds of extraction time.

Thus, in certain embodiments, a method of using the plurality of extraction chambers 102A advantageously may obtain a shot of extraction material with a Total Dissolved Solids (TDS) between 4 percent and 10 percent with an extraction time of less than 30 seconds. For example, the TDS may be a measure of coffee compounds that have been extracted by water into the beverage. The TDS may be a measure of concentration of the beverage produced. TDS may be expressed as a percentage or as grams per liter (g/L). When expressed as a percentage, TDS represents the mass of all the solids dissolved in the solution divided by the mass of the solution. When expressed as grams per liter (g/L), TDS represents the mass (in grams) of solids dissolved in a liter of solution. In some embodiments, a method of using the plurality of extraction chambers 102A may obtain a shot of extraction material with a TDS between 6 percent and 8 percent with an extraction time of less than 30 seconds. In some embodiments, a method of using the plurality of extraction chambers 102A may obtain a shot of extraction material with a TDS between 4 percent and 10 percent with an extraction time of less than 20 seconds. In some embodiments, a method of using the plurality of extraction chambers 102A may obtain a shot of extraction material with a TDS between 6 percent and 8 percent with an extraction time of less than 20 seconds. In some embodiments, a method of using the plurality of extraction chambers 102A may obtain a shot of extraction material with a TDS between 4 percent and 10 percent with an extraction time between about 1 second and about 30 seconds. In some embodiments, a method of using the plurality of extraction chambers 102A may obtain a shot of extraction material with a TDS between 4 percent and 10 percent with an extraction time between about 5 seconds and about 20 seconds. In some embodiments, a method of using the plurality of extraction chambers 102A may obtain a shot of extraction material with a TDS between 4 percent and 10 percent with an extraction time between about 10 seconds and about 20 seconds. In some embodiments, a method of using the plurality of extraction chambers 102A may obtain a shot of extraction material with a TDS between 6 percent and 8 percent with an extraction time between about 1 second and about 30 seconds. In some embodiments, a method of using the plurality of extraction chambers 102A may obtain a shot of extraction material with a TDS between 6 percent and 8 percent with an extraction time between about 5 seconds and about 20 seconds. In some embodiments, a method of using the plurality of extraction chambers 102A may obtain a shot of extraction material with a TDS between 6 percent and 8 percent with an extraction time between about 10 seconds and about 20 seconds. In certain embodiments, a method of using the plurality of extraction chambers 102A may reduce the extraction time between 10 percent and 70 percent, as measured by double shot standards, while maintaining, at least maintaining, and/or enhancing a volume of the shot of extraction material, a dose of extraction material, TDS, and/or a flavor profile of the shot of extraction material. In certain embodiments, a method of using the plurality of extraction chambers 102A may reduce the extraction time between 25 percent and 70 percent, as measured by double shot standards, while maintaining, at least maintaining and/or enhancing a volume of the shot of extraction material, a dose of extraction material, TDS, and/or a flavor profile of the shot of extraction material. In certain embodiments, a method of using the plurality of extraction chambers 102A may reduce the extraction time between 50 percent and 70 percent, as measured by double shot standards, while maintaining at least maintaining, and/or enhancing a volume of the shot of extraction material, a dose of extraction material, TDS, and/or a flavor profile of the shot of extraction material.

In should be appreciated that in certain embodiments, the various ranges described above may be combined in various combinations, for example, the provided ranges of the grind size, the temperature, the interior volume 108, the combined interior volume 108A, the length, the width, the extraction time, and/or the TDS may be used and claimed in various combinations.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like). As used herein, the term “double shot standards,” includes in an embodiment of a shot of extraction material between 36 grams and 45 grams extracted from a dose of extraction material between 13 grams and 19 grams, with a pressure of the extraction medium between 9 bars and 11 bars, at a temperature between 90.5° C. (195° F.) and 96° C. (205° F.), and an extraction time between 15 seconds and 30 seconds.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range such that disclosing “about 1 gram” in the specification supports claiming “1 gram” in the claims. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of preparing edible extracts and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A method of preparing an extract, the method comprising:
loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³;
introducing a flow of extraction medium through the plurality of extraction chambers;
withdrawing the extraction medium through the plurality of extraction chambers,
wherein a TDS of the withdrawn extraction medium is between 4 percent and 10 percent and an extraction time of the withdrawn extraction medium is less than 20 seconds.

2. The method of claim 1, wherein the flow of extraction medium through the plurality of extraction chamber is introduced at a pressure between 1 bar and 12 bar.

3. The method of claim 1, wherein each extraction chamber has a length between 0.2 cm and 10 cm.

4. The method of claim 1 where there are between 2 to 10 extraction chambers.

5. The method of claim 1, wherein a temperature of the extraction medium is between about 85° C. and about 97° C.

6. The method of claim 1, wherein the extraction material comprises coffee.

7. An extraction device for preparing an extract, the extraction device comprising:
a plurality of extraction chambers, each extraction chamber having an interior volume for the extraction material and having a length (L) and a width (W) perpendicular to the length, wherein the aspect ratio A is defined by dividing the length (L) by the width (W) and the aspect ratio A is between 0.15 and 3.0 and wherein the interior volume of each extraction chamber is between 200 mm³ and 15,000 mm³.

8. The extraction device claim 7, the extraction material comprises a grind size between 200 microns and 400 microns.

9. The extraction device of claim 7, wherein each extraction chamber has a length between 0.2 cm and 10 cm.

10. The extraction device of claim 7 comprising between 2 to 10 extraction chambers.

11. The extraction device of claim 7, wherein each extraction chamber comprises a same aspect ratio A.

12. A method of preparing an extract, the method comprising:
loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³;
introducing a flow of extraction medium through the plurality of extraction chambers;
withdrawing the extraction medium through the plurality of extraction chambers.

13. The method of claim 12, wherein each extraction chamber has a length between 0.2 cm and 10 cm.

14. The method of claim 12, wherein the flow of extraction medium is introduced through each of the plurality of extraction chambers at a same time.

15. The method of claim 14, wherein the extraction medium is withdrawn through the plurality of extraction chambers at a same time.

16. The method of claim 12, wherein the temperature of the extraction medium is between about 85° C. and about 97° C.

17. The method of claim 12, wherein an extraction time of the withdrawn extraction medium is reduced between 25 and 70 percent, as measured by double shot standards.

18. A method of preparing an extract, the method comprising:
loading extraction material into a plurality of extraction chambers formed within an extraction device, each extraction chamber forming a volume for the extraction material, each extraction chamber having a length (L) and a width (W) perpendicular to the length, wherein the aspect ratio A is defined by dividing the length (L) by the width (W) and the aspect ratio A of each extraction chamber is between 0.15 and 3.0 and wherein the volume of each extraction chamber is between 200 mm³ and 40,000 mm³;
introducing a flow of extraction medium through the plurality of extraction chambers;
withdrawing the extraction medium through the plurality of extraction chambers,
wherein an extraction time of the withdrawn extraction medium is reduced between 10 percent and 70 percent, as measured by double shot standards, while maintaining a volume of the withdrawn extraction medium and/or a TDS of the extraction medium.

19. The method of claim 18, wherein the withdrawn extraction medium has a TDS between 4 percent and 10 percent.

20. The method of claim 18, wherein the extraction device comprises between 2 to 10 extraction chambers.

21. The method of claim 18, wherein the temperature of the extraction medium is between about 85° C. and about 97° C.
